(19) United States
(12) Patent Application Publication
(10) Pub. No.: US 2007/0285949 A1
(43) Pub. Date: Dec. 13, 2007

(54) LED track lighting system

(75) Inventors: Pervaiz Lodhie, Rolling Hills, CA (US); Kevin T. Sweeney, Lomita, CA (US)

Correspondence Address: IRVING KESCHNER, 21535 HAWTHORNE BOULEVARD, SUITE 385, TORRANCE, CA, 90503, US

(73) Assignee: Ledtronics Inc.

(21) Appl. No.: 11/448,933

(22) Filed: Jun. 8, 2006

(51) Int. Cl. H01R 33/00

(52) U.S. Cl. 362/648

(57) ABSTRACT

A track lighting system wherein a module having a plurality of LEDs mounted thereto is placed within a channel shaped rail system, the module being positionable within the rail system. A first surface of a first printed circuit board (PCB) is positioned on the bottom surface of the rail system and a pair of parallel conductive members are positioned on the second surface of the PCB. The bottom surface of the module has a plurality of spaced openings through which are inserted input power detents which contact corresponding conductive members. The power detents are connected to a circuit which converts the 24 VDC power input to a constant current; the output of the circuit being coupled to a second PCB upon which is mounted the LEDs. Openings are formed in the sides of the rail system and detents, positioned on the sides of the module, engage corresponding openings formed in the rail system sides to lock the module in position within the rail system.

### BACKGROUND OF THE INVENTION

1. Field of the Invention

The present invention provides a track lighting system having a slide-in LED module.

2. Description of the Prior Art

A track fixture is a light-producing luminaire with a fixture adapter mount and its electrical power connections. Power for the fixtures is provided from an electrical junction box main, connected to the track by an end-feed track-to-junction box connector. A number of depending track fixtures are positionable along the track and have luminaires that are mechanically and electrically connected to the track conductors with fixture mounting adapters. Line-voltage luminaries are connected to track conductors directly through a fixture adapter. Low-voltage luminaries are connected through a low-voltage power converter attached to a fixture adapter that is in turn mechanically and electrically connected to the track. Gas-discharge luminaries are connected through a ballast power converter attached to a fixture adapter that is mechanically and electrically connected to the track.

The conventional luminaries noted hereinabove have various disadvantages associated therewith. For example, fluorescent (and incandescent) tube luminaries are expensive and have a relatively short operating life. Further, the conventional fixture adapter mount used in the track lighting system is fixed in position after the system is installed.

A light-emitting diode (LED) is a semiconductor device that emits light when a current passes through it and wherein the current can pass in only one direction.

LEDs are in general more efficient, last longer, and are more durable than fluorescent and incandescent lamps. In general, LEDs are about 4 times more efficient at producing light than fluorescent lamps, and approximately 16 times more efficient at producing light than incandescent lamps. Unlike fluorescent and incandescent lamps, LEDs are extremely shock resistant. While an incandescent lamp may produce light for 750 to 2,000 operating hours, and a fluorescent lamp may produce light for 12,000 to 24,000 hours on continuous use, many LEDs can product light for 100,000 hours of continuous use. For the above reasons, LEDs are generally preferred over fluorescent and incandescent lamps in many applications.

What is thus desired is to provide a track fixture that utilizes a luminaire that has a long operating life and wherein the fixture can be easily positioned at different locations within the rail.

### SUMMARY OF THE INVENTION

The present invention provides a track lighting system wherein a module having a plurality of LEDs mounted thereto is placed within a channel shaped rail system, the module being positionable within the rail system. A first surface of a first printed circuit board (PCB) is positioned on the bottom surface of the rail system and a pair of parallel conductive members are positioned on the second surface of the PCB. The bottom surface of the module has a plurality of spaced openings through which are inserted input power detents which contact corresponding conductive members. The power detents are connected to a circuit which converts the 24 VDC power input to a constant current; the output of the circuit being coupled to a second PCB upon which is mounted the LEDs. Openings are formed in the sides of the rail and detents, positioned on the corresponding sides of the module, lock the module in position within the rail system.

The present invention thus provides a LED track lighting system which is a significant improvement of the track lighting systems currently in use.

### DESCRIPTION OF THE DRAWINGS

For a better understanding of the present invention as well as other objects and further features thereof, reference is made to the following description which is to be read in conjunction with the accompanying drawing therein:

FIG. 1 is a perspective view of the LED tracking lighting system of the present invention;

FIG. 2 is a cross-sectional view along line 2-2 of FIG. 1;

FIG. 3 is a cross-sectional view along line 3-3 of FIG. 1;

FIG. 4 is a cross-sectional view along line 4-4 of FIG. 1

FIG. 5 is a cross-sectional view along line 5-5 of FIG. 1;

FIG. 6 is a perspective view of the present invention; and

FIG. 7 is a simple electrical schematic of the LED energizing configuration.

### DESCRIPTION OF THE INVENTION

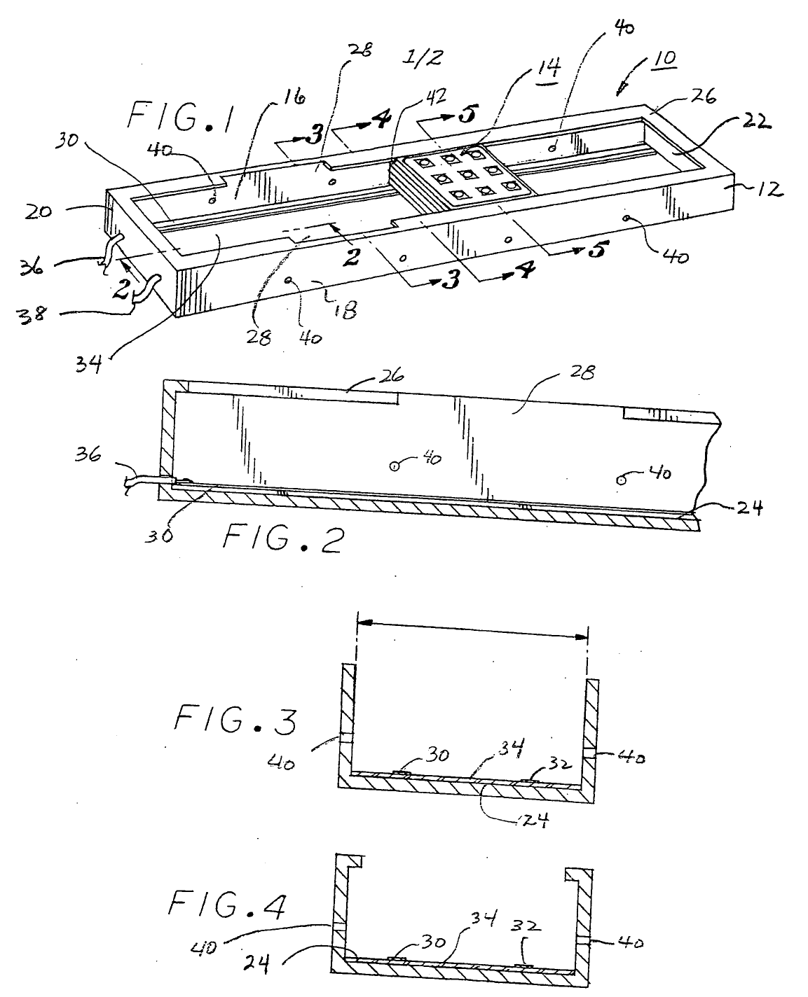

Referring now to FIG. 1, a perspective view of the LED track lighting system 10 of the present invention is illustrated. System 10 comprises a track, or rail, 12 having a LED module 14 positioned therewithin. Rail system 12 comprises a housing having side portions 16 and 18, ends 20 and 22 and bottom surface 24 (FIGS. 2-5). A lip portion 26 extends inwardly from the housing, lip portion 26 including a pair of indentations, or breaks, 28 formed therein to enable module 14 to be inserted within the track as will be explained hereinafter. Conductors, or bus bars, 30 and 32 are positioned on the top surface of a printed circuit board 34. A DC power source is coupled to wires 36 and 38, which in turn, are connected to bus bars 30 and 32, respectively thereby providing the lighting power to module 14.

As will be set forth in more detail hereinafter, housing side portions 16 and 18 include a plurality of spaced openings 40 adapted to receive locking detents.

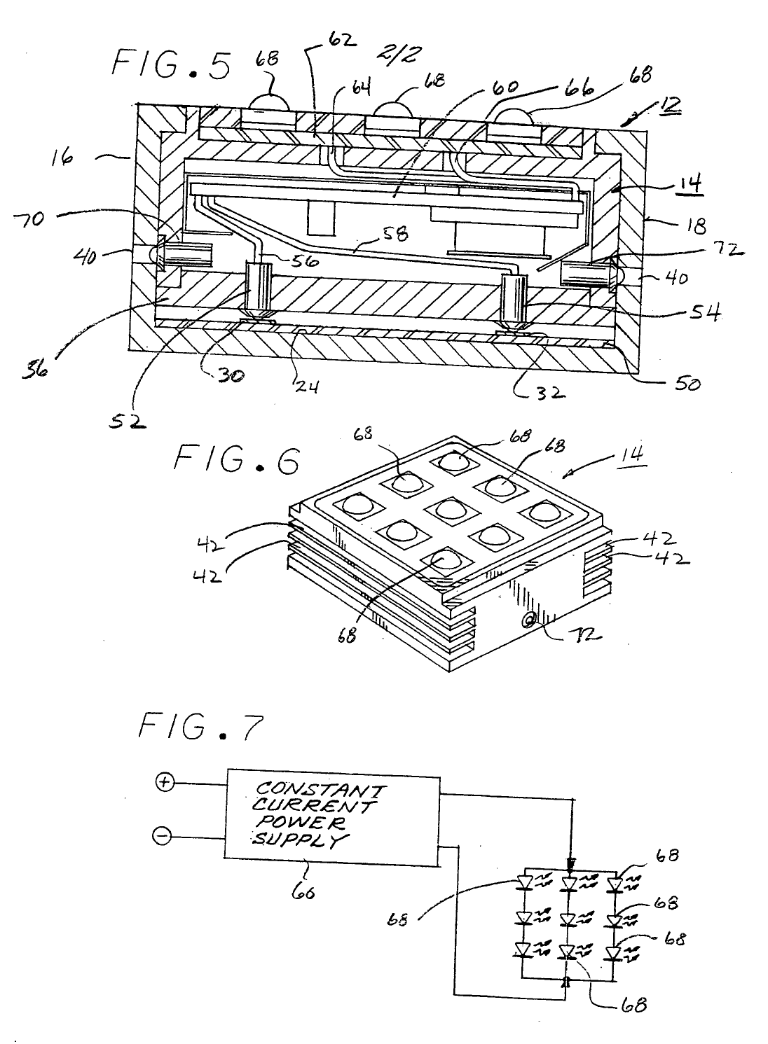

Referring to FIG. 5, the cross-sectional view illustrates details of module 14. The two sides of module 14 not contacting the sides of track 12 have a plurality of slots 42 formed therein (shown clearly in FIG. 6) which function as a heat sink to dissipate heat generated during operation of system 10. A 24 VDC printed circuit board (PCB) 50 is positioned on top of surface 24 of rail 12 and bus bars 30 and 32 are mounted on the top surface of PCB 50. Power detents 52 and 54 are secured within apertures formed in cover member 56, the tip of detents 52 and 54 contacting bus bars 30 and 32, respectively. Power wires 56 and 58 connect detents 52 and 54, respectively, to constant current power supply 60. The output of constant current power supply 60 (a dc to dc converter) is coupled to PCB 62 via power wires 64 and 66. Mounted to PCB 62 are a plurality of LED members 68 (although nine LED members are shown in FIG. 6, different numbers of LEDs can be utilized dependent on the dimensions of track 12 and module 14). Spring detents 70 and 72 are secured within side walls 74 and 76, respectively, of module 14 and function to lock module 14 in place within track 12.

As illustrated in FIG. 5, when module 14 is inserted within track 12 and properly located, the tip of the detents extend into the corresponding holes 40 formed in the sidewalls of track 12. Constant current power supply 60 converts a dc supply voltage (in the range between 15-50 VDC) to a voltage suitable for the LED configuration illustrated. Power supply 60 automatically adjusts the output to maintain a constant current to the LEDs (approximately 300 μa for each parallel circuit). This maintains a consistent light output with a varying input voltage and protects the circuits from voltage spikes.

FIG. 7 is a schematic illustrating the connection of constant power supply 60 across the parallel connection of LEDs 68. In the configuration illustrated, three parallel arms of LEDs comprising three LEDs connected in series, form the LED array for module 14 although other LED arrangements can be utilized.

In addition to the advantages of using LEDs as the track lighting system luminaire as set forth hereinabove, modules in addition to the sole module shown in FIG. 1 can be easily installed depending on the lighting requirements of the user, the length of track 12 limiting the number of modules utilized. For example, for a typical track length of 12 inches, five modules 14 can be utilized for the size and orientation of module 14 as illustrated. The dimensions of module 14 which has been successfully utilized is as follows: width 2.25 inches; height 0.92 inches; length 2.225 inches (does not include the height of the LEDs and detents). As soon as module 14 is locked into place within track 12, LEDs 68 are energized and emit their characteristic illumination. Module 14 is bipolar in that it can be locked into place in either direction, providing a great deal of flexibility in the installation process.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A track lighting system comprising:
an enclosure of a predetermined length, said enclosure comprising first and second sidewalls and a bottom surface;
first and second conductive tracks supported adjacent said enclosure bottom surface;
a first module having a bottom surface, first and second sides and a plurality of lighting elements mounted thereon, first and second conductive members mounted in openings formed in the bottom surface of said first module, said first and second conductive members having first and second top portions, respectively, the top portions of said first and second conductive members contacting said first and second tracks, respectively, when said first module is positioned within said enclosure;
means for applying electrical power to said first and second conductive tracks; and
means for connecting said first and second conductive members to said lighting elements whereby said lighting elements emit illumination.

2. The lighting system of claim 1 wherein said lighting elements comprise LEDs.

3. The lighting system of claim 2 wherein said LEDs are formed in a plurality of rows and columns.

4. The system of claim 1 wherein said first and second sidewalls have a plurality of openings formed along their length.

5. The system of claim 4 wherein said module sides each have a retractable member mounted therein, said retractable members each having a head portion.

6. The system of claim 5 wherein the head portions of said retractable members fit into adjacent openings formed in said first and second sidewalls when said module is positioned within said enclosure thereby securing said module within said enclosure.

7. The system of claim 2 wherein said LEDs are mounted on a printed circuit board.

8. The system of claim 1 wherein a second module is positioned within said enclosure.
